(19) United States
(12) Patent Application Publication
(10) Pub. No.: US 2026/0191277 A1
(43) Pub. Date: Jul. 9, 2026

(54) NON-CONTACT TEMPERATURE MONITORING OF HEATED TOBACCO PRODUCTS USING CURIE POINT

(71) Applicant: Altria Client Services LLC, Richmond, VA (US)

(72) Inventors: James YORKSHADES, Gamlingay (GB); Tristan HUGHES, Sandy (GB); Callum FRANKS, Wixams (GB); Katherine WEILBACHER, Apollo Beach, FL (US); Rangaraj S. SUNDAR, Midlothian, VA (US); Raymond W. LAU, Glen Allen, VA (US); Eric HAWES, Midlothian, VA (US)

(73) Assignee: Altria Client Services LLC, Richmond, VA (US)

(21) Appl. No.: 19/442,396

(22) Filed: Jan. 7, 2026

Related U.S. Application Data
(60) Provisional application No. 63/742,978, filed on Jan. 8, 2025.

(51) Int. Cl. A24F 40/57; A24F 40/20; A24F 40/465; A24F 40/51; A24F 40/53; G01K 3/00; G01K 7/38; H05B 6/10

(52) U.S. Cl. CPC A24F 40/57; A24F 40/20; A24F 40/465; A24F 40/51; A24F 40/53; G01K 3/005; G01K 7/38; H05B 6/105

(57) ABSTRACT

An aerosol generating device including a heater configured to generate heat for heating an aerosol generating product; and processing circuitry configured to cause the aerosol generating device to use at least one inductive coil to monitor a magnetic permeability of a temperature sensing element, determine a temperature of the aerosol generating product based on the monitored magnetic permeability, and control the heating of the aerosol generating product based on the determined temperature.

### CROSS-REFERENCE TO RELATED APPLICATION

This application claims the benefit of U.S. Provisional Application 63/742,978 filed on

Jan. 8, 2025, the disclosure of which is incorporated by reference herein in its entirety.

### BACKGROUND

### Field

The present disclosure relates to a product and method for a non-contact monitoring of the temperature of a heated aerosol-producing product using a change in the magnetic permeability of a temperature sensing element.

### Description of Related Art

Some electronics are configured to heat an aerosol-forming substrate, for example a plant material such as tobacco and/or cannabis, to a temperature that is sufficient to release constituents of the aerosol-forming substrate while keeping the temperature below an ignition point of the aerosol-forming substrate so as to avoid any substantial pyrolysis of the aerosol-forming substrate. Such devices may be referred to as aerosol-generating devices (e.g., heated aerosol-generating devices). In some instances, the aerosol-forming substrate may be introduced directly into a heater chamber of an aerosol-generating device. In other instances, the aerosol-forming substrate may be pre-packaged in individual containers or consumables to facilitate insertion and removal from an aerosol-generating device.

### SUMMARY

At least one example embodiment relates to an aerosol generating device including a heater configured to generate heat for heating an aerosol generating product; and processing circuitry configured to cause the aerosol generating device to, use at least one inductive coil to monitor a magnetic permeability of a temperature sensing element, determine a temperature of the aerosol generating product based on the monitored magnetic permeability, and control the heating of the aerosol generating product based on the determined temperature.

At least one embodiment relates to a method of controlling a temperature of an aerosol generating product in an induction based aerosol generating product, the method including heating the aerosol generating product; monitoring a magnetic permeability of one or more temperature sensing elements; determining the temperature of the aerosol generating product based on the monitored magnetic permeability of the one or more temperature sensing elements; and controlling the heating based on the determined temperature.

At least one embodiment relates to system comprising processing circuitry; and a non-transitory storage medium storing instructions configured to, when executed by the processing circuitry, causes the processing circuitry to monitor a magnetic permeability of one or more temperature sensing elements, determine at least one temperature of an aerosol generating product based on the monitored magnetic permeability, and control the at least one temperature of the aerosol generating product based on the determined at least one temperature.

### BRIEF DESCRIPTION OF THE DRAWINGS

The various features and advantages of the non-limiting embodiments herein may become more apparent upon review of the detailed description in conjunction with the accompanying drawings. The accompanying drawings are merely provided for illustrative purposes and should not be interpreted to limit the scope of the claims. The accompanying drawings are not to be considered as drawn to scale unless explicitly noted. For purposes of clarity, various dimensions of the drawings may have been exaggerated.

FIG. 1 is a diagram of an aerosol generating device with an inductive heating system according to at least one example embodiment.

FIG. 2 is an example cartridge according to at least one embodiment.

FIGS. 3A, 3B, and 3C are schematics illustrating example positions for temperature sensing elements in a tobacco bed.

FIG. 4 is a graph representing a change in magnetic permeability.

FIGS. 5A and 5B illustrate configurations of example monitoring circuits.

FIG. 6 is a diagram of an aerosol generating device with an inductive heating system according to at least one example embodiment.

FIG. 7 is a flow chart illustrating a method of operating an aerosol generating device according to at least one embodiment.

### DETAILED DESCRIPTION OF EXAMPLE EMBODIMENTS

Some detailed example embodiments are disclosed herein. However, specific structural and functional details disclosed herein are merely representative for purposes of describing example embodiments. Example embodiments may, however, be embodied in many alternate forms and should not be construed as limited to only the example embodiments set forth herein.

Accordingly, while example embodiments are capable of various modifications and alternative forms, example embodiments thereof are shown by way of example in the drawings and will herein be described in detail. It should be understood, however, that there is no intent to limit example embodiments to the particular forms disclosed, but to the contrary, example embodiments are to cover all modifications, equivalents, and alternatives falling within the scope of example embodiments. Like numbers refer to like elements throughout the description of the figures.

Functional elements, such as those that perform and/or are configured to perform at least one function or operation may be implemented with processing circuitry such as hardware, software, and/or a combination of hardware and software. For example, the processing circuitry more specifically may include (and/or be included in), but is not limited to, a central processing unit (CPU), an arithmetic logic unit (ALU), a digital signal processor, a microcomputer, a field programmable gate array (FPGA), a System-on-Chip (SoC), a programmable logic unit, a microprocessor, application-specific integrated circuit (ASIC), circuits including active and/or passive elements (e.g., transistors, capacitors, resistors, etc.), and/or the like. In at least some embodiments, the processing circuitry may, for example, be configured to execute instructions stored in a non-transitory computer readable media. The term “non-transitory,” as used herein, is a description of the medium itself (e.g., as tangible, and not a signal) as opposed to a limitation on data storage persistency (e.g., RAM vs. ROM). For example, the computer-readable recording medium may be any tangible medium that can store or include the program in or connected to an instruction execution system, equipment, or device. Examples of the storage medium include magnetic media such as hard disks, floppy disks, and magnetic tapes; optical media such as CD-ROM and DVDs; magneto-optical media such as floptical disks; and hardware devices that are specially configured to store and perform program instructions, such as ROM, RAM, flash memory, and/or the like.

It should be understood that when an element or layer is referred to as being “on,” “connected to,” “coupled to,” or “covering” another element or layer, it may be directly on, connected to, coupled to, or covering the other element or layer or intervening elements or layers may be present. In contrast, when an element is referred to as being “directly on,” “directly connected to,” or “directly coupled to” another element or layer, there are no intervening elements or layers present. Like numbers refer to like elements throughout the specification. As used herein, the term “and/or” includes any and all combinations of one or more of the associated listed items.

It should be understood that, although the terms first, second, third, etc. may be used herein to describe various elements, components, regions, layers and/or sections, these elements, components, regions, layers, and/or sections should not be limited by these terms. These terms are only used to distinguish one element, component, region, layer, or section from another region, layer, or section. Thus, a first element, component, region, layer, or section discussed below could be termed a second element, component, region, layer, or section without departing from the teachings of example embodiments.

Spatially relative terms (e.g., “beneath,” “below,” “lower,” “above,” “upper,” and the like) may be used herein for ease of description to describe one element or feature's relationship to another element(s) or feature(s) as illustrated in the figures. It should be understood that the spatially relative terms are intended to encompass different orientations of the device in use or operation in addition to the orientation depicted in the figures. For example, if the device in the figures is turned over, elements described as “below” or “beneath” other elements or features would then be oriented “above” the other elements or features. Thus, the term “below” may encompass both an orientation of above and below. Accordingly, the device may be otherwise oriented (rotated 90 degrees or at other orientations) and the spatially relative descriptors used herein interpreted accordingly.

The terminology used herein is for the purpose of describing various example embodiments only and is not intended to be limiting of example embodiments. As used herein, the singular forms “a,” “an,” and “the” are intended to include the plural forms as well, unless the context clearly indicates otherwise. It will be further understood that the terms “includes,” “including,” “comprises,” and/or “comprising,” when used in this specification, specify the presence of stated features, integers, steps, operations, elements, and/or components, but do not preclude the presence or addition of one or more other features, integers, steps, operations, elements, components, and/or groups thereof.

Example embodiments are described herein with reference to cross-sectional illustrations that are schematic illustrations of idealized embodiments (and intermediate structures) of example embodiments. As such, variations from the shapes of the illustrations as a result, for example, of manufacturing techniques and/or tolerances, are to be expected. Thus, example embodiments should not be construed as limited to the shapes of regions illustrated herein but are to include deviations in shapes that result, for example, from manufacturing. Further, when the terms “about” or “substantially” are used in this specification in connection with a numerical value and/or geometric terms, it is intended that the associated numerical value includes a manufacturing tolerance (e.g., ±10%) around the stated numerical value. Further, regardless of whether numerical values and/or geometric terms are modified as “about” or “substantially,” it will be understood that these values should be construed as including a manufacturing or operational tolerance (e.g., ±10%) around the stated numerical values and/or geometry.

Unless otherwise defined, all terms (including technical and scientific terms) used herein have the same meaning as commonly understood by one of ordinary skills in the art to which example embodiments belong. It will be further understood that terms, including those defined in commonly used dictionaries, should be interpreted as having a meaning that is consistent with their meaning in the context of the relevant art and will not be interpreted in an idealized or overly formal sense unless expressly so defined herein.

As discussed herein, an aerosol-forming substrate is a material or combination of materials that may yield an aerosol. An aerosol relates to the matter generated or output by the devices disclosed, claimed, and equivalents thereof. The material may include a compound (e.g., nicotine, cannabinoid, cannabimimetic agent) that is released when the material is heated. In such an instance, an aerosol including the compound is produced when the material is heated. The heating may be below the ignition temperature so as to avoid a self-sustaining burning or a self-sustaining combustion of the material (i.e., in contrast to where a material is lit, such as lit-end cigarettes). It is understood that heating of a material below its ignition temperature may, in some circumstances, produce incidental and insubstantial levels of oxidized or other thermal decomposition byproducts. However, in some embodiments, the heating in aerosol-generating devices is below the pyrolysis temperature of the material so as to produce an aerosol having no or insubstantial levels of thermal decomposition byproducts of the material. Thus, in an example embodiment, pyrolysis of the material does not occur during the heating and resulting production of aerosol. In other instances, there may be incidental pyrolysis, with production of oxidized or other thermal decomposition byproducts at levels that are insignificant relative to the primary constituents released by heating of the material.

The material(s) of the aerosol-forming substrate may include a fibrous material. For instance, the fibrous material may be a botanical material. The fibrous material is configured to release a compound when heated. The compound may be a naturally occurring constituent of the fibrous material. For instance, the fibrous material may be plant material such as tobacco, and the compound released may be nicotine. The term “tobacco” includes any tobacco plant material including tobacco leaf, tobacco plug, reconstituted tobacco, compressed tobacco, shaped tobacco, or powder tobacco, and combinations thereof from one or more species of tobacco plants, such as Nicotiana rustica and Nicotiana tabacum.

In some example embodiments, the tobacco material may include material from any member of the genus Nicotiana. In addition, the tobacco material may include a blend of two or more different tobacco varieties. Examples of suitable types of tobacco materials that may be used include, but are not limited to, flue-cured tobacco, Burley tobacco, Dark tobacco, Maryland tobacco, Oriental tobacco, rare tobacco, specialty tobacco, blends thereof, and the like. The tobacco material may be provided in any suitable form, including, but not limited to, tobacco lamina, processed tobacco materials, such as volume expanded or puffed tobacco, processed tobacco stems, such as cut-rolled or cut-puffed stems, reconstituted tobacco materials, blends thereof, and the like. In some example embodiments, the tobacco material is in the form of a substantially dry tobacco mass. Furthermore, in some instances, the tobacco material may be mixed and/or combined with at least one of propylene glycol, glycerin, sub-combinations thereof, or combinations thereof.

The compound in the generated aerosol may also be a naturally occurring constituent of a medicinal plant that has a medically-accepted physiological effect (e.g., therapeutic effect, prophylactic effect). For instance, the medicinal plant may be a cannabis plant or a cannabimimetic plant (i.e., a plant with similar pharmacological effects to those of cannabis). For a cannabis plant, the compound may be a cannabinoid. Cannabinoids interact with receptors in the body to produce a wide range of effects. As a result, cannabinoids have been used for a variety of medicinal purposes (e.g., treatment of pain, nausea, epilepsy, psychiatric disorders). The fibrous material may include the leaf and/or flower material from one or more species of cannabis plants such as Cannabis sativa, Cannabis indica, and Cannabis ruderalis. In some instances, the fibrous material is a mixture of 60-80% (e.g., 70%) Cannabis sativa and 20-40% (e.g., 30%) Cannabis indica. For a cannabimimetic plant, the compound may be a cannabimimetic agent. Cannabimimetic agents interact with receptors in the body to produce similar pharmacological effects as cannabinoids.

Examples of cannabinoids include tetrahydrocannabinolic acid (THCA), tetrahydrocannabinol (THC), cannabidiolic acid (CBDA), cannabidiol (CBD), cannabinol (CBN), cannabicyclol (CBL), cannabichromene (CBC), and cannabigerol (CBG). Tetrahydrocannabinolic acid (THCA) is a precursor of tetrahydrocannabinol (THC), while cannabidiolic acid (CBDA) is precursor of cannabidiol (CBD). Tetrahydrocannabinolic acid (THCA) and cannabidiolic acid (CBDA) may be converted to tetrahydrocannabinol (THC) and cannabidiol (CBD), respectively, via heating. In an example embodiment, heat from a heater may cause decarboxylation so as to convert the tetrahydrocannabinolic acid (THCA) to tetrahydrocannabinol (THC), and/or to convert the cannabidiolic acid (CBDA) to cannabidiol (CBD).

In instances where both tetrahydrocannabinolic acid (THCA) and tetrahydrocannabinol (THC) are present, the decarboxylation and resulting conversion will cause a decrease in tetrahydrocannabinolic acid (THCA) and an increase in tetrahydrocannabinol (THC). At least 50% (e.g., at least 87%) of the tetrahydrocannabinolic acid (THCA) may be converted to tetrahydrocannabinol (THC) during the heating. Similarly, in instances where both cannabidiolic acid (CBDA) and cannabidiol (CBD) are present, the decarboxylation and resulting conversion will cause a decrease in cannabidiolic acid (CBDA) and an increase in cannabidiol (CBD). At least 50% (e.g., at least 87%) of the cannabidiolic acid (CBDA) may be converted to cannabidiol (CBD) during the heating.

Furthermore, the compound which is released may be or may additionally include a non-naturally occurring additive that is subsequently introduced into the fibrous material. In one instance, the fibrous material may include at least one of cotton, polyethylene, polyester, rayon, combinations thereof, or the like (e.g., in a form of a gauze). In another instance, the fibrous material may be a cellulose material (e.g., non-tobacco and/or non-cannabis material). In either instance, the compound introduced may include nicotine, cannabinoids, cannabimimetic agents, and/or flavorants. The flavorants may be from natural sources, such as plant extracts (e.g., tobacco extract, cannabis extract, cannabimimetic extract), and/or artificial sources. In yet another instance, when the fibrous material includes tobacco and/or cannabis, the compound may be or may additionally include one or more flavorants (e.g., menthol, mint, vanilla). Thus, the compound within the aerosol-forming substrate may include naturally occurring constituents and/or non-naturally occurring additives. In this regard, it should be understood that existing levels of the naturally occurring constituents of the aerosol-forming substrate may be increased through supplementation. For example, the existing levels of nicotine in a quantity of tobacco may be increased through supplementation with an extract containing nicotine. Similarly, the existing levels of one or more cannabinoids in a quantity of cannabis may be increased through supplementation with an extract containing such cannabinoids. Likewise, the existing levels of one or more cannabimimetic agents in a quantity of cannabimimetic material may be increased through supplementation with an extract containing such cannabimimetic agents.

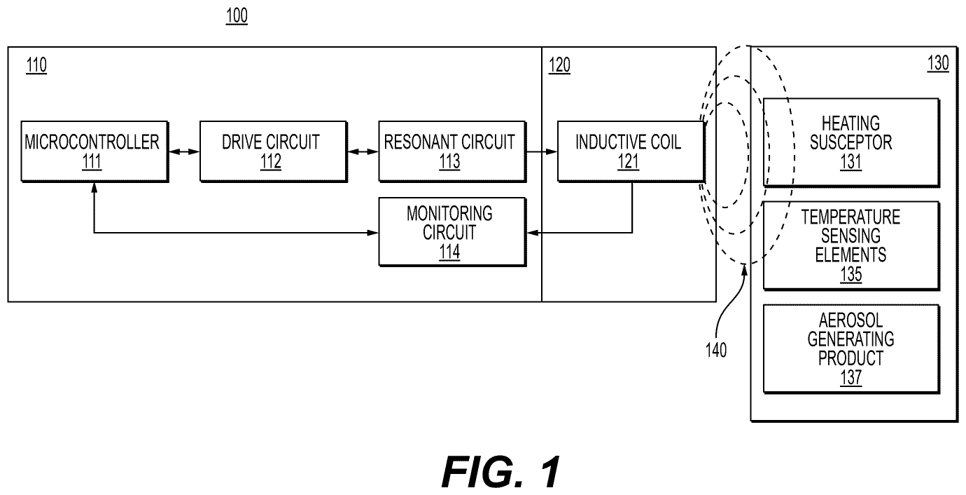

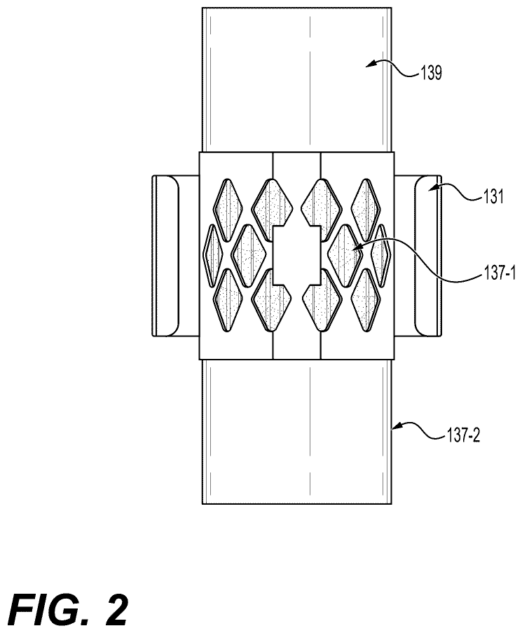

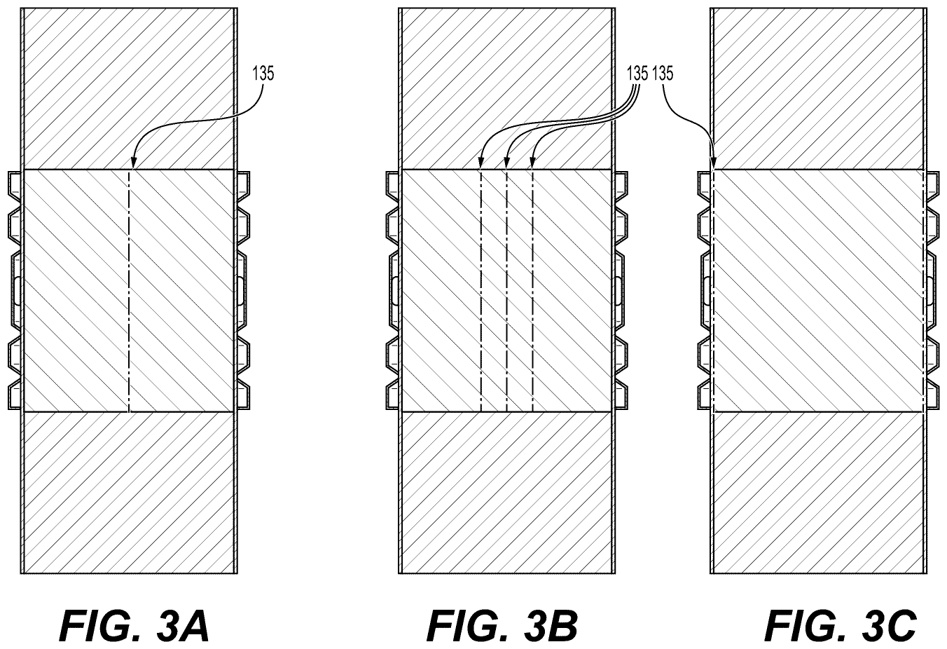

FIG. 1 is a diagram of an aerosol generating device with an inductive heating system according to at least one example embodiment; FIG. 2 is an example cartridge according to at least one embodiment; and FIGS. 3A, 3B, and 3C are schematics illustrating example positions for temperature sensing elements in a tobacco bed.

According to at least one example embodiment, an aerosol generating device 100 may include a heating chamber 120 configured to induce the heating of an aerosol generating product 137 (e.g., an aerosol-forming substrate such as tobacco, tobacco product, etc., a volatile liquid, and/or the like) and processing circuitry 110 configured to control the heating of the aerosol generating product 137.

For example, in at least one embodiment, the heating chamber 120 may be configured to receive a cartridge 130 including the aerosol generating product 137, a heating susceptor 131, and at least one temperature sensing element 135 such that the cartridge 130 is separatable from the heating chamber 120. In these cases, the cartridge 130 further includes an opening (not illustrated) through which the generated aerosol may exit. Alternatively, in at least one embodiment, the aerosol generating device 100 may be a unitary system, such that the heating chamber 120 includes the heating susceptor 131, the at least one temperature sensing element 135 and a substrate or bed configured to hold, e.g., the heated tobacco and/or heated tobacco product. In these cases, the heating chamber 120 further includes an opening (not illustrated) through which the aerosol generated may exit.

For example, as illustrated in FIG. 2, the cartridge 130 may include a pair of heating susceptor elements configured to form the heating susceptor 131. The heating susceptor elements may be configured to surround the aerosol generating product 137. In at least some embodiments, the heating susceptor elements may be further configured to secure the cartridge 130 in the heating chamber 120.

The aerosol generating product 137 may be (and/or include) a tobacco substrate 137-1 secured by a wrapper 137-2 (illustrated as a transparent wrapper for clarity but is not limited thereto). The cartridge 130 may further include an endcap 139 at each end of the aerosol generating product 137. At least one of the endcaps 139 may be a filter through which the generated aerosol may exit.

The heating chamber 120 may include a heater. For example, in at least one embodiment, the heater may be an inductive heater and include an inductive coil 121 configured to induce eddy currents in the heating susceptor 131. For example, the induction coil 121 may be configured to be electromagnetically coupled with the heating susceptor 131 and may include, for example, a helical shape encircling the capsule and/or a coil shape coplanar to a surface of the capsule; however, the shape of the inductive coil 121 is not limited thereto.

The induction coil 121 may be connected to and controlled by the processing circuitry 110. For example, the processing circuitry 110 may include a microcontroller 111 configured to control the operation of the aerosol generating device 100. For example, the microcontroller 111 may execute a command (and/or a series of commands) utilized during the operation of the aerosol generating device 100 and, in response to an instruction to heat the aerosol generating product 137 (e.g., in response to a user command) the microcontroller 111 may send a command to a drive circuit 112. In response to the receiving the command, the drive circuit 112 may control the operation of the resonant circuit 113 and/or the inductive coil 121. For example, the drive circuit 112 may be configured to control the supply of current (and/or wattage) to the resonant circuit 113 based on the command received from the microcontroller 111. The resonant circuit 113 may convert the supplied current (and/or wattage) to a resonant (or oscillating) signal and supply the resonant signal to the inductive coil 121 such that the inductive coil 121 produces an oscillating electromagnetic field 140.

For example, in at least one embodiment, the resonant circuit 113 may be configured to generate an alternating current (AC) within inductive coil 121 which results in the generation of an electromagnetic field within the induction coil 121 and/or the resonant circuit 113. In at least one embodiment, the inductive coil 121 may include a coil/capacitor (LC) circuit wherein a reactance of the coil (L) is the same (and/or substantially similar) to the reactance of the capacitor (C).

The aerosol generating device 100 may be configured to use the oscillating electromagnetic field 140 to induce induction heating using the heating susceptor 131 (also referred herein as a “susceptor”). In at least one embodiment, the first inductive coil 121 may include a coil/capacitor (LC) circuit wherein a reactance of the coil is the same (and/or substantially similar) to the reactance of the capacitor, thereby generating an oscillating electromagnetic field with a frequency corresponding to the reactance of the coil and/or of the capacitor. The oscillating electromagnetic field 140 may result in the eddy currents generated in the heating susceptor 131 to also switch directions rapidly, which results in the heating susceptor 131 generating heat. The heat may then be transferred (e.g., through conductance, convention, radiance, etc.) to one or more temperature sensing elements 135 and to the aerosol generating product 137. However, the embodiments are not limited thereto. For example, in some embodiments, the heater may including one or more heating elements, wherein the one or more heating elements is at least one of resistive, microwave, convective, or infrared (IR). For example, the heating elements may each be (and/or include) a resistive heating element, a microwave generator, a convective heating element, an infrared (IR) generator, and/or the like. In these cases, the processing circuitry 110 may be configured to control the supply of current to the heating elements and the at least one temperature sensing element 135 may be electrically isolated from the heater. In these cases, the heater may be configured to irradiate the aerosol generating product 138 with an electromagnetic radiation having a heating frequency, and oscillating electromagnetic field 140 may have a frequency spectrally separate from the heating frequency. Additionally, in some of these cases, the heating susceptor 131 may be omitted.

The heating of the aerosol generating product 137 may result in volatile compounds included therein to be converted to an aerosol (e.g., through evaporation and/or sublimation). However, overheating of the aerosol generating product 137 may also result in unwanted compounds being aerosolized and/or the production of unwanted by-products (e.g., through degradation and/or oxidation). In order to prevent said overheating, the aerosol generating device 100 uses the one or more temperature sensing elements 135 to monitor the temperature of the heating susceptor 131 and/or the aerosol generating product 137.

For example, the processing circuitry 110 may further include a monitoring circuit 114 configured to monitor the inductive coil 121 and/or the resonant circuit 113; and the cartridge 130 may include one or more temperature sensing elements 135 with a Curie Point at or below an overheating temperature of the aerosol generating product 137.

For example, in at least one embodiment, the one or more temperature sensing elements 135 may be (and/or include) one or more metal strips with a Curie point selected for a temperature at and/or below the overheating temperature. For example, in at least one embodiment, the one or more metal strips may be placed within a tobacco bed and/or substrate to be heated, outside of the tobacco bed and/or substrate to be heated, in contact with the heating element, and/or a combination of locations. The one or more metal strips may be a single continuous strip or multiple strips. In at least one embodiment, the multiple strips may include different Curie points for different selected temperatures and/or used to monitor the temperature at different locations.

FIGS. 3A, 3B, and 3C are schematics illustrating example positions for temperature sensing elements in a tobacco bed.

As illustrated in FIGS. 3A to 3C, the one or more metal strips comprising the temperature sensing elements 135 may be a single metal strip in (or embedded in) the center of the substrate (FIG. 3A), a plurality of strips in the substrate (FIG. 3B), a column around (or surrounding) the substrate (FIG. 3C), a combination thereof, and/or the like. In at least one example embodiment, the column may include one or more metal strips surrounding the substrate.

In at least one embodiment, the one or more metal strips may undergo a reversable phase change (e.g., from a ferromagnetic phase to a paramagnetic phase when heated above the Curie point and back to the ferromagnetic phase when cooled below the Curie point), thereby resulting in a change in the magnetic permeability of the one or more metal strips. In at least one embodiment, the one or more metal strips included in the one or more temperature sensing elements 135 may be, and/or include, for example, a metal such as nickel, tin, iron, steel, chromium, molybdenum, an alloy thereof, and/or the like. In at least one embodiment, the one or more temperature sensing elements 135 may be (and/or include) one or more material strips including a metal and/or one or more ferrites such as manganese-zinc, nickel-zinc, cobalt ferrites, and/or the like. In at least one embodiment, the one or more temperature sensing elements 135 may be, and/or include, at least one of nickel, one or more ferrites, and/or a nickel-iron alloy.

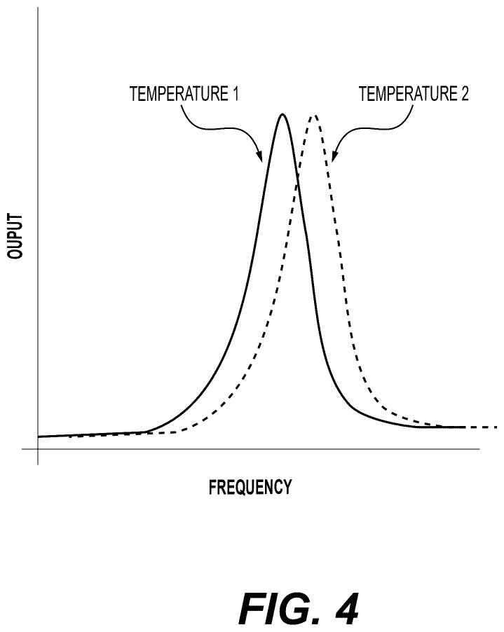

FIG. 4 is a graph representing a change in magnetic permeability. More specifically, the graph illustrates an output response of the resonant circuit 113 and/or LC circuit at a frequency at a temperature 1 (below the Curie point of the metal strip) and at a temperature 2 (above the Curie point of the metal strip). As shown in the graph, the output response v. frequency characteristic shifts depending on whether the temperature of the metal strip is above or below the Curie point. By monitoring for the shift in output response of the resonant circuit 113 and/or LC circuit, it may be determined whether the metal strip is at or above the Curie temperature for the metal strip. Additionally, in examples wherein there are a plurality of metal strips and the plurality of metal strips have a plurality of Curie temperatures (e.g., wherein at least some of the metal strips have different Curie temperatures and/or different Curie points), the shifts in the output response v. frequency characteristics may also be used to determine the temperature of the plurality of metal strips, as the plurality of metal strips may be configured such that each plurality of Curie temperatures may have a corresponding output response v. frequency.

Referring to FIGS. 1 and 4, the monitoring circuit 114 may, thereby, be configured to determine whether the temperature of the one or more temperature sensing elements 135 has reached (or surpassed) the selected Curie point by monitoring the reactance of the inductive coil 121 and/or the resonant circuit 113 to determine whether the magnetic permeability of the at least one temperature sensing element 135 has changed; and the microcontroller 111 may control the operations of the drive circuit 112 based on a determination that the magnetic permeability of the element included in the oscillating magnetic field 140 has changed.

For example, in at least one embodiment, the monitoring circuit 114 may be configured to monitor the voltage applied to the resonant circuit 113 to determine whether there is a change in the voltage output at a known inductance. When the temperature of the temperature sensing elements 135 exceed the curie point of the temperature sensing elements 135, the magnetic permeability of the temperature sensing elements 135 changes, thereby causing a shift in inductance in the LC resonant circuit. As illustrated in FIG. 4, this causes a change in the output voltage of the LC resonance circuit, which the monitoring circuit 114, according to some example, is configured to detect.

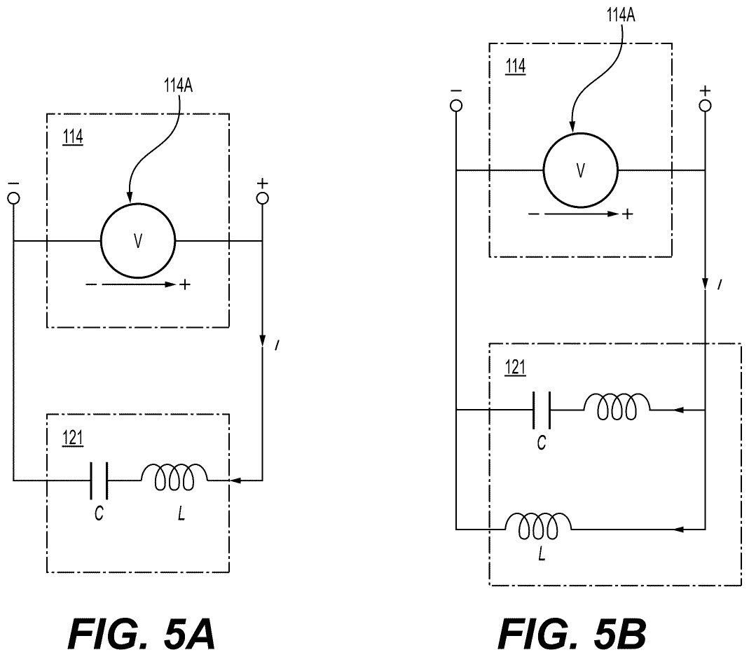

FIGS. 5A and 5B illustrate configurations of example monitoring circuits. In at least some embodiments, the monitoring circuit 114 includes a voltage detector 114a (e.g., a voltmeter) configured to detect a voltage difference Vₛ in a current I across a series LC resonant (FIG. 5A) and/or a parallel LC circuit (FIG. 5B).

In at least one embodiment, the microcontroller 111 may continuously determine the temperature of the metal sensing strip or strips using data captured by the monitoring circuit 114. For example, in at least one example, the microcontroller 111 may be configured to calculate the temperature of the metal sensing strip or strips in real time. For example, in at least one example, the magnetic permeability of the metal sensing strip or strips is continuously monitored, and, data captured by the monitoring circuit 114 is applied to an algorithm on the microcontroller 111 to determine, in real time, whether the temperature is at or above a threshold temperature and/or what the temperature of the metal sensing strip or strips in real time; and the calculated temperature may be used in a control loop, including a PID (proportional, integral and derivative) controller (not illustrated) to manage the heating system and regulate the temperature of the aerosol generating product 137. Additionally, in at least some embodiments, the plurality of metal strips may be arranged such that the microcontroller 111 may perform multi-zone temperatures monitoring. For example, the inductive coil 121 may be one of a plurality of inductive coils 121, the monitoring circuit 114 one may be one of a plurality of the monitoring circuits 114, and/or at least one temperature sensing elements 135 may be included in a plurality of sensing elements 135, all arranged to form multiple zones in the aerosol generating product 137, and the microcontroller 111 may be configured to monitor the temperature of one or more of the zones. For example, in at least one embodiment, the microcontroller 111 be configured to synthesize a spatial temperature map representing the one or more temperatures of the aerosol generating product 137, and may be configured to control the heating of individual zones based on the spatial temperature map.

For example, in at least one embodiment, the PID loop will take the input temperature data from the monitoring circuits 114 alongside a target temperature. Then, by incorporating feedback from the system output, apply PID mathematical functions to determine a new output value to enable the system to achieve the target temperature.

Similarly, a simple on-off control loop could be implemented whereby the heater output is enabled if the temperature falls below the target temperature & disabled when it rises above.

In both examples, the control loop runs continuously during heating operations to ensure the correct temperature is maintained within an operational tolerance (e.g. 10% or less).

In at least some embodiments, the control loops may be configured such that the target temperature may be adjusted during heating operations to compensate for other external inputs.

In at least one embodiment, the Curie point of the one or more temperature sensing elements 135 may be selected as a threshold temperature, such that the heating of the heating susceptor is paused (or stopped) when the one or more temperature sensing elements 135 of the reaches the Curie point. Additionally, in at least one embodiment, the one or more temperature sensing elements 135 may be tuned to have a gradual phase transition and include a plurality of Curie points such that the microcontroller 111 may monitoring for a change of temperature changes. For example, the one or more temperature sensing elements 135 may include a plurality of metal strips with different Curie points, and/or a solid solution including phases with different Curie points.

The microcontroller 111 may then direct the drive circuit 112 to adjust, slow, and/or pause the induction heating in order to prevent (or reduce the potential for) the aerosol generating product 137 from overheating. For example, the microcontroller 111 may generate and transmit a command code to the drive circuit 112 to stop the heating, reduce the duration of power being provided to the resonant circuit, increasing the duration of time between when power is being provided to the resonant circuit, etc. Additionally, since the microcontroller 111 may continuously determine the temperature of the metal sensing strip or strips using data captured from the monitoring circuit 114, a wired connection and/or additional temperature monitoring devices may be omitted from the aerosol generating device 100.

For example, wherein the one or more temperature sensing elements 135 includes a metal strip with a Curie temperature tuned to be below a threshold temperature (e.g., a temperature wherein the aerosol generating product 137 would generate the aerosol and below a carry-over temperature, wherein thermal carry-over would overheat the aerosol generating product, and/or below a burn temperature, wherein the aerosol generating product 137 would burn (e.g., ignite and/or under pyrolysis), the microcontroller 111 may be configured to pause the induction heating; and/or wherein the one or more temperature sensing elements 135 includes a plurality of Curie temperatures, the microcontroller 111 may be configured to increase the heating of the aerosol generating product 137 below a minimum threshold temperature (e.g., a lower temperature wherein the aerosol generating product 137 would generate the aerosol), slow down the induction heating between the minimum threshold temperature and the threshold temperature, and pause the induction heating at and/or about the threshold temperature. In at least one embodiment, the threshold temperature may be less than an ignition temperature and/or the pyrolysis temperature of the aerosol generating product.

In at least one embodiment, the monitoring circuit 114 may further be configured to monitor, e.g., the reactance of the resonant circuit 113 and the inductive coil 121, and the processing circuitry 110 may be configured to adjust the supply of power (e.g., current and/or wattage) to the resonant circuit 113 and/or inductive coil 121 in order to maintain and/or control the induction heating.

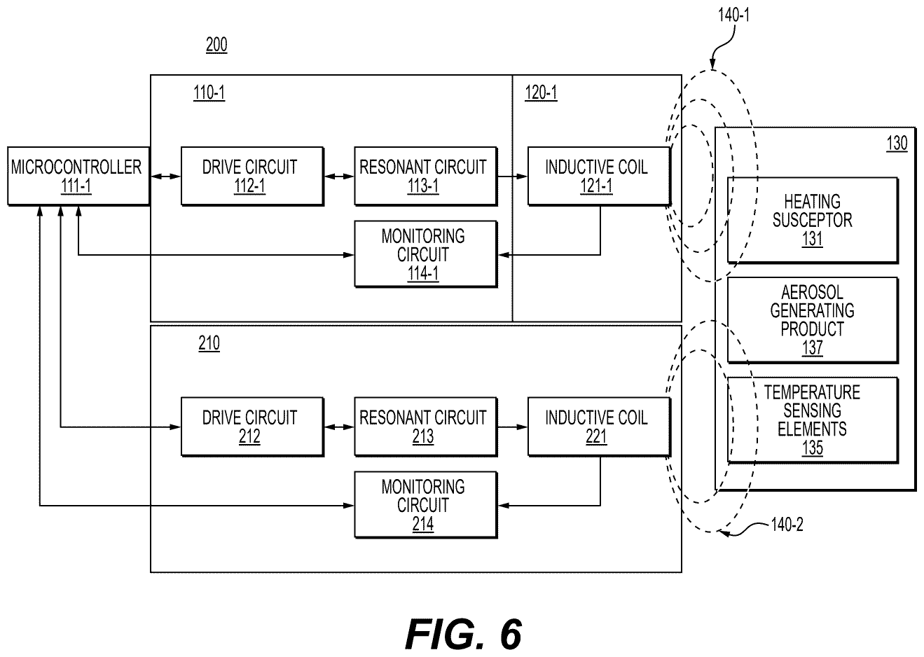

FIG. 6 is a diagram of an aerosol generating device with an inductive heating system according to at least one example embodiment.

According to at least one example embodiment, an aerosol generating device 200 may include a heating chamber 120-1 configured to induce the heating of an aerosol generating product 137 (e.g., tobacco, a volatile liquid, etc.) and processing circuitry configured to control the heating of the aerosol generating product 137. More example, the processing circuitry of the aerosol generating device 200 may include the microcontroller 111-1, a power delivery circuit 110-1, and a non-contact temperature sensing circuit 210.

The heating chamber 120-1 and the cartridge 130-1 of aerosol generating device 200 may be the same as, and/or substantially similar to the heating chamber 120 and the cartridge 130 described with reference to FIG. 1; therefor, repeat descriptions thereof may be omitted.

In at least one embodiment, the power delivery circuit 110-1 may include, e.g., a first driving circuit 112-1, a first resonant circuit 113-1, and a first monitoring circuit 114-1.

In at least one embodiment, the first resonant circuit 113-1 may be configured to generate an alternating current (AC) within the first inductive coil 121-1 which results in the generation of an electromagnetic field within the first induction coil 121-1 and/or the resonant circuit first 113-1. In at least one embodiment, the first inductive coil 121-1 may include a coil/capacitor (LC) circuit wherein a reactance of the coil is the same (and/or substantially similar) to the reactance of the capacitor, thereby generating an oscillating electromagnetic field with a frequency based on the reactance. The oscillating electromagnetic field 140-1 may result in the eddy currents generated in the heating susceptor 131-1 to also switch directions rapidly, which results in the heating susceptor 131-1 generating heat. Additionally, hysteretic losses in the heating susceptor 131-1 may also contribute to the heat generation.

The monitoring circuit 114-1 may further be configured to monitor, e.g., the reactance of the resonant circuit 113-1 and the inductive coil 121-1, and the power delivery circuit 110-1 may be configured to adjust the supply of power (e.g., current and/or wattage) to the resonant circuit 113-1 and/or inductive coil 121-1 in order to maintain and/or control the induction heating. For example, the monitoring circuit 114-1 may be configured to monitor for a shift in the inductance of the LC resonant circuit and/or for hysteretic losses in the heating susceptor 131-1.

In at least one embodiment, the non-contact temperature sensing circuit 210 may include, e.g., a second driving circuit 212, a second resonant circuit 213, a second monitoring circuit 214, and a second inductive coil 221.

The second drive circuit 212 may control the operation of the second resonant circuit 213 and/or the second inductive coil 221 in response to the receiving the command from the microcontroller 111-1. For example, the second drive circuit 212 may be configured to control the supply of current (and/or wattage) to the second resonant circuit 213 based on a command received from the microcontroller 111-1. The second resonant circuit 213 may convert the supplied current (and/or wattage) to a resonant (or oscillating) signal and supply the resonant signal to the second inductive coil 221 such that the second inductive coil 221 produces a second oscillating electromagnetic field 140-2 with a different frequency compared to the oscillating electromagnetic field 140-1 produced by the first inductive coil 121-1.

Thereby, the second monitoring circuit 214 may be configured to monitor for a change in the magnetic permeability of the at least one temperature sensing elements 135 and to determine whether the temperature of one or more of the at least one temperature sensing elements 135 has reached (or surpassed) a selected Curie point by monitoring the reactance of the second inductive coil 221 and/or the second resonant circuit 213 to determine whether the magnetic permeability of the at least one temperature sensing element 135 has changed; and the microcontroller 111-1 may control the operations of the first drive circuit 112 based on a determination that the magnetic permeability of the element included in the second oscillating magnetic field 140-2 has changed.

In at least one embodiment, multi-zone temperature monitoring may be performed using the first inductive coil 121-1 and the second inductive coil 221. In at least one embodiment, the first inductive coil 121-1 and the second inductive coil 221 may be located at different locations. For example, in at least one example embodiment, the heating susceptor 131 may be (and/or be included in) a heating substrate (not illustrated) and the first inductive coil 121-1 may be configured to induce heating in the heating substrate, while the second inductive coil 221 may be configured to be electromagnetically coupled to temperature sensing elements 135 spaced apart from the heating substrate and/or nearer to the aerosol generating product 137. However, the example embodiments are not limited thereto. For example, in at least one embodiment the first inductive coil 121-1 and the second inductive coil 221 may overlap.

The microcontroller 111 may then direct the first drive circuit 112-1 to adjust, slow, and/or pause the induction heating in order to prevent (or reduce the potential for) the aerosol generating product 137 from overheating. For example, the first drive circuit 112-1 may be configured to operate based on the command received from the microcontroller 111-1. Additionally, since the microcontroller 111-1 may continuously monitor the temperature of the metal sensing strip or strips based on changes to the magnetic permeability of the at least one temperature sensing elements 135, a wired connection and/or additional temperature monitoring devices may be omitted from the aerosol generating device 200.

Additionally, in at least one example embodiment, the aerosol generating device 100 and/or 200 may include, e.g., a plurality of LC circuits configured to be electromagnetically coupled to corresponding heating susceptors and/or temperature sensing elements, such that the aerosol generating device 100 and/or 200 is configured to heat and/or monitor the temperature of the aerosol generating product 137 at different locations.

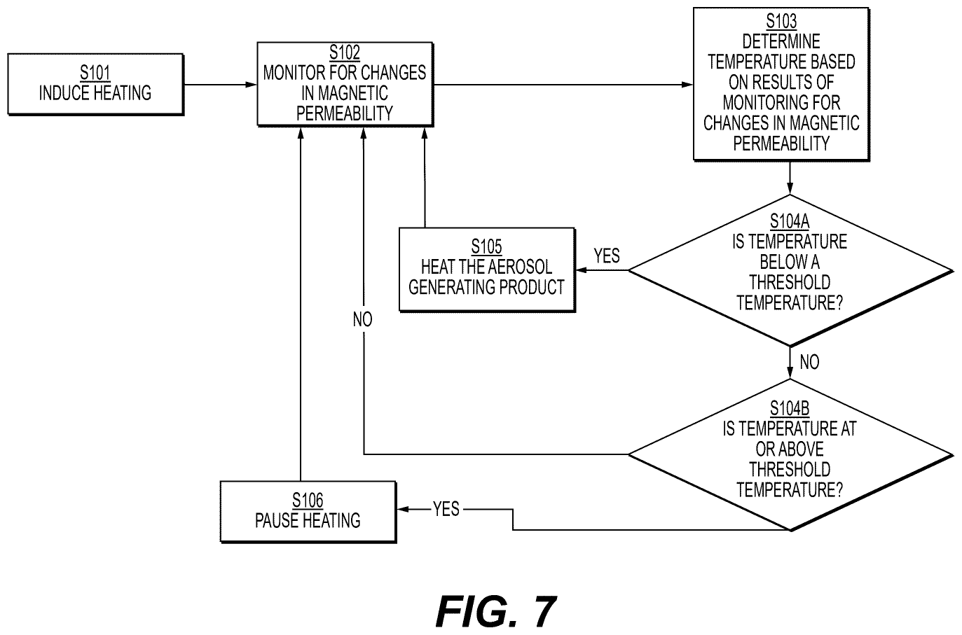

FIG. 7 is a flow chart illustrating a method of operating an aerosol generating device according to at least one embodiment. The method may be performed by, e.g., at least one of the aerosol generating devices 100 and/or 200, but for brevity will be described in reference to the aerosol generating device 100.

At operation S101, the aerosol generating device 100 heats the heating susceptor 131, the one or more temperature sensing elements 135, and the aerosol generating product 137 through induction heating.

At operation S102, the processing circuitry 110 monitors for a change in the magnetic permeability of the one or more temperature sensing elements 135. For example, the monitoring circuit 114 may determine a reactance of the output of the inductive coil 121 at a frequency, and compare the reactance to a reference.

At operation S103, the processing circuitry 110 determines the temperature of the heating susceptor 131, the one or more temperature sensing elements 135, and/or the aerosol generating product 137 based on the results of monitoring for the change in magnetic permeability. For example, in at least one embodiment, the temperature is continuously determined by running an algorithm on the microcontroller 111 using the data captured by the monitoring circuit 114.

At operations S104A and S104B, the processing circuitry 110 determines whether the temperature of the heating susceptor 131, the one or more temperature sensing elements 135, and/or the aerosol generating product 137 is at and/or above a threshold temperature. For example, in operation S104A, the processing circuitry 110 may determine whether the temperature of the heating susceptor 131, the one or more temperature sensing elements 135, and/or the aerosol generating product 137 is below a threshold temperature.

Alternatively, the processing circuitry 110 may determine that the temperature of the heating susceptor 131, the one or more temperature sensing elements 135, and/or the aerosol generating product 137 has reached and/or has exceeded the threshold temperature. For example, in at least one embodiment, the processing circuitry 110 may determine whether the aerosol generating product 137 is about to overheat.

If the temperature of the heating susceptor 131, the one or more temperature sensing elements 135, and/or the aerosol generating product 137 is determined to be not at and/or above the threshold temperature (e.g., as a result of operation S104A and/or based on a determination that the aerosol generating product 137 is not about to overheat), the processing circuitry 110 may continue and/or restart the heating of the heating susceptor 131, the one or more temperature sensing elements 135, and/or the aerosol generating product 137 (operation S105). Thereafter, the method may return to operation S102.

Alternatively, at operation S106, based on a determination that the temperature the temperature of the heating susceptor 131, the one or more temperature sensing elements 135, and/or the aerosol generating product 137 is at and/or above the threshold temperature (e.g., as a result of operation S104B and/or based on a determination that the aerosol generating product 137 is about to overheat), the processing circuitry 110 may pause (or stop) the heating of the temperature the temperature of the heating susceptor 131, the one or more temperature sensing elements 135, and/or the aerosol generating product 137. Thereafter, the method may return to operation S102.

Thus, operations S102 through S106 may be repeated. In at least one embodiment, operations S102 through S105 may be repeated until a command to stop the heating is received. For example, the command to stop may be received in response to a user command turning off the aerosol generating device 100, in response to expiration of a timer, in response to the inductive coil 121 being electromagnetically decoupled from the cartridge 130; in response to a determination that the aerosol generating device 100 performed operation S105 two or more times within a predetermined time frame, and/or the like.

Illustrative embodiment 1. An aerosol generating device comprising: a heater configured to generate heat for heating an aerosol generating product; and processing circuitry configured to cause the aerosol generating device to, use at least one inductive coil to monitor a magnetic permeability of a temperature sensing element, determine a temperature of the aerosol generating product based on the monitored magnetic permeability, and control the heating of the aerosol generating product based on the determined temperature.

Illustrative embodiment 2. The aerosol generating device of illustrative embodiment 1, wherein the heater includes a heating susceptor, and wherein the at least one inductive coil is configured to generate an oscillating electromagnetic field, the at least one inductive coil connected to a resonant circuit configured to control the oscillating electromagnetic field such that oscillating eddy currents are generated in the heating susceptor.

Illustrative embodiment 3. The aerosol generating device of illustrative embodiment 1, wherein the heater includes a heating element, wherein the heating element is at least one of resistive, microwave, convective, or infrared (IR), and the temperature sensing element is electrically isolated from the heater.

Illustrative embodiment 4. The aerosol generating device of any one of illustrative embodiments 1-3, wherein the processing circuitry is configured to monitor for a change in the magnetic permeability of the temperature sensing element.

Illustrative embodiment 5. The aerosol generating device of illustrative embodiment 4, wherein a Curie point of the temperature sensing element is configured to be at or below a burn temperature of the aerosol generating product.

Illustrative embodiment 6. The aerosol generating device of any one of illustrative embodiments 4-5, wherein the processing circuitry is configured to pause or reduce the heating when the change in the magnetic permeability of the temperature sensing element is detected.

Illustrative embodiment 7. The aerosol generating device of any one of illustrative embodiments 1-6, wherein the temperature sensing element includes at least one material strip.

Illustrative embodiment 8. The aerosol generating device of illustrative embodiment 7, wherein the temperature sensing element includes at least one material strip comprising at least one of nickel, ferrites, or a nickel-iron alloy.

Illustrative embodiment 9. The aerosol generating device of any one of illustrative embodiments 7-8, wherein the at least one material strip is included in the aerosol generating product.

Illustrative embodiment 10. The aerosol generating device of any one of illustrative embodiments 7-9, wherein the at least one material strip includes a plurality of material strips in the aerosol generating product.

Illustrative embodiment 11. The aerosol generating device of any one of illustrative embodiments 7-10, wherein the at least one material strip surrounds the aerosol generating product, is embedded within the aerosol generating product, or a combination thereof.

Illustrative embodiment 12. The aerosol generating device of any one of illustrative embodiments 1-11, wherein the at least one inductive coil includes a first inductive coil configured to generate a first oscillating electromagnetic field of a first frequency configured to induce eddy currents in a heating susceptor, and at least one second inductive coil configured to generate a second oscillating electromagnetic field of a second frequency, different from the first frequency, configured to monitor the magnetic permeability.

Illustrative embodiment 13. The aerosol generating device of any one of illustrative embodiments 1-12, wherein the processing circuitry is configured to synthesize a spatial temperature map of the aerosol generating product.

Illustrative embodiment 14. The aerosol generating device of any one of illustrative embodiment 1-13, further comprising: a heating chamber configured to receive a capsule, the capsule including the aerosol generating product and the temperature sensing element.

Illustrative embodiment 15. The aerosol generating device of illustrative embodiment 1, wherein the heater includes an inductive heater, and the inductive heater including the at least one inductive coil and is configured to generate an oscillating electromagnetic field in a heating susceptor, the heating susceptor and the temperature sensing element are included in a tobacco bed, and the at least one inductive coil is configured to induce heating of the tobacco bed.

Illustrative embodiment 16. The aerosol generating device of illustrative embodiment 1, wherein the heater includes an inductive heater, and the inductive heater including the at least one inductive coil and is configured to generate an oscillating electromagnetic field in a heating susceptor, and the heating susceptor surrounds the aerosol generating product.

Illustrative embodiment 17. A method of controlling a temperature of an aerosol generating product, the method including: heating the aerosol generating product; monitoring a magnetic permeability of one or more temperature sensing elements; determining the temperature of the aerosol generating product based on the monitored magnetic permeability of the one or more temperature sensing elements; and controlling the heating based on the determined temperature.

Illustrative embodiment 18. The method of illustrative embodiment 17, wherein a Curie point of the one or more temperature sensing elements is configured to be at or below a burn temperature of the aerosol generating product.

Illustrative embodiment 19. The method of any one of illustrative embodiments 17-18, wherein the controlling the heating includes at least one of pausing or slowing the heating based on a determination that the determined temperature is equal to or greater than a threshold temperature.

Illustrative embodiment 20. The method of illustrative embodiment 19, wherein the threshold temperature is below a burn temperature of the aerosol generating product.

Illustrative embodiment 21. The method of illustrative embodiment 17, wherein the heating the aerosol generating product includes generating a first oscillating electromagnetic field of a first frequency configured to induce an eddy current in a heating susceptor, and wherein the monitoring the magnetic permeability of the one or more temperature sensing elements includes generating a second oscillating electromagnetic field of a second frequency, different from the first frequency, configured to detect the magnetic permeability.

Illustrative embodiment 22. The method of illustrative embodiment 17, wherein the heating the aerosol generating product includes irradiating the aerosol generating product with an electromagnetic radiation having a heating frequency, and wherein the monitoring the magnetic permeability of the one or more temperature sensing elements including generating an oscillating electromagnetic field of a frequency spectrally separate from the heating frequency.

Illustrative embodiment 23. The method of any one of illustrative embodiments 17-22, wherein the monitoring the magnetic permeability of the one or more temperature sensing elements includes monitoring for a change in the magnetic permeability of the one or more temperature sensing elements.

Illustrative embodiment 24. The method of illustrative embodiment 23, wherein the change in the magnetic permeability of the one or more temperature sensing elements results from the temperature increasing above a Curie point of the one or more temperature sensing elements.

Illustrative embodiment 25. The method of any one of illustrative embodiments 17-23, wherein controlling the heating based on the determined temperature includes, increasing the temperature at or below a first threshold temperature, and pausing the heating at or above a second threshold temperature.

Illustrative embodiment 26. The method of any one of illustrative embodiments 17-25, wherein the one or more temperature sensing elements is included in a plurality of temperature sensing elements, and the monitoring of the magnetic permeability of the temperature sensing element and the determining the temperature of the aerosol generating product includes, determining, in real time, the temperature of the aerosol generating product based at least one change to the magnetic permeability of the plurality of temperature sensing elements.

Illustrative embodiment 27. A system comprising: processing circuitry; and a non-transitory storage medium storing instructions configured to, when executed by the processing circuitry, causes the processing circuitry to monitor a magnetic permeability of one or more temperature sensing elements, determine at least one temperature of an aerosol generating product based on the monitored magnetic permeability, and control the at least one temperature of the aerosol generating product based on the determined at least one temperature.

Illustrative embodiment 28. The system of illustrative embodiment 27, wherein the instructions are configured to, when executed by processing circuitry, cause the processing circuitry to control the at least one temperature of the aerosol generating product by causing the processing circuitry to pause or slow heating of the aerosol generating product based on a determination that one or more of the determined at least one temperatures is equal to or greater than a threshold temperature.

Illustrative embodiment 29. The system of any one of illustrative embodiments 27-28, wherein the threshold temperature is below a burn temperature of the aerosol generating product.

Illustrative embodiment 30. The system of any one of illustrative embodiments 27-29,wherein the instructions are configured to, when executed by the processing circuitry, cause the processing circuitry to monitor the magnetic permeability of the one or more temperature sensing elements by causing the processing circuitry to monitor for a change in the magnetic permeability of the one or more temperature sensing elements.

Illustrative embodiment 31. The system of any one of illustrative embodiments 27-30, wherein the instructions are configured to, when executed by the processing circuitry, cause the processing circuitry to control the at least one temperature of the aerosol generating product based on the determined at least one temperature by causing the processing circuitry to increase the at least one temperature based on a determination that one or more of the at least one determined temperatures is at or below a first threshold temperature, and pause the increase of the at least one temperature based on a determination that one or more of the at least one determined temperatures is at or above a second threshold temperature.

Example embodiments have been disclosed herein; it should be understood that other variations may be possible. Such variations are not to be regarded as a departure from the spirit and scope of the present disclosure, and all such modifications as would be obvious to one skilled in the art are intended to be included within the scope of the following claims.

We claim:

1. An aerosol generating device comprising:
a heater configured to generate heat for heating an aerosol generating product; and
processing circuitry configured to cause the aerosol generating device to,
use at least one inductive coil to monitor a magnetic permeability of a temperature sensing element,
determine a temperature of the aerosol generating product based on the monitored magnetic permeability, and
control the heating of the aerosol generating product based on the determined temperature.

2. The aerosol generating device of claim 1, wherein the heater includes a heating susceptor, and
wherein the at least one inductive coil is configured to generate an oscillating electromagnetic field, the at least one inductive coil connected to a resonant circuit configured to control the oscillating electromagnetic field such that oscillating eddy currents are generated in the heating susceptor.

3. The aerosol generating device of claim 1, wherein the heater includes a heating element,
wherein the heating element is at least one of resistive, microwave, convective, or infrared (IR), and
the temperature sensing element is electrically isolated from the heater.

4. The aerosol generating device of claim 1, wherein the processing circuitry is configured to monitor for a change in the magnetic permeability of the temperature sensing element.

5. The aerosol generating device of claim 4, wherein a Curie point of the temperature sensing element is configured to be at or below a burn temperature of the aerosol generating product.

6. The aerosol generating device of claim 4, wherein the processing circuitry is configured to pause or reduce the heating when the change in the magnetic permeability of the temperature sensing element is detected.

7. The aerosol generating device of claim 1, wherein the temperature sensing element includes at least one material strip.

8. The aerosol generating device of claim 7, wherein the at least one material strip includes at least one of nickel, ferrites, or a nickel-iron alloy.

9. The aerosol generating device of claim 7, wherein the at least one material strip includes a plurality of material strips in the aerosol generating product.

10. The aerosol generating device of claim 7, wherein the at least one material strip surrounds the aerosol generating product, is embedded within the aerosol generating product, or a combination thereof.

11. The aerosol generating device of claim 1, wherein the at least one inductive coil includes
a first inductive coil configured to generate a first oscillating electromagnetic field of a first frequency configured to induce eddy currents in a heating susceptor, and
at least one second inductive coil configured to generate a second oscillating electromagnetic field of a second frequency, different from the first frequency, configured to monitor the magnetic permeability.

12. The aerosol generating device of claim 1, wherein the processing circuitry is configured to synthesize a spatial temperature map of the aerosol generating product.

13. The aerosol generating device of claim 1, further comprising:
a heating chamber configured to receive a capsule, the capsule including the aerosol generating product, and the temperature sensing element.

14. The aerosol generating device of claim 1, wherein the heater includes an inductive heater, and the inductive heater including the at least one inductive coil and is configured to generate an oscillating electromagnetic field in a heating susceptor,
the heating susceptor and the temperature sensing element are included in a tobacco bed, and
the at least one inductive coil is configured to induce heating of the tobacco bed.

15. The aerosol generating device of claim 1, wherein the heater includes an inductive heater, and the inductive heater including the at least one inductive coil and is configured to generate an oscillating electromagnetic field in a heating susceptor, and the heating susceptor surrounds the aerosol generating product.

16. A system comprising:
processing circuitry; and
a non-transitory storage medium storing instructions configured to, when executed by the processing circuitry, causes the processing circuitry to
monitor a magnetic permeability of one or more temperature sensing elements,
determine at least one temperature of an aerosol generating product based on the monitored magnetic permeability, and
control the at least one temperature of the aerosol generating product based on the determined at least one temperature.

17. The system of claim 16, wherein the instructions are configured to, when executed by processing circuitry, cause the processing circuitry to control the at least one temperature of the aerosol generating product by causing the processing circuitry to pause or slow heating of the aerosol generating product based on a determination that one or more of the determined at least one temperatures is equal to or greater than a threshold temperature.

18. The system of claim 17, wherein the threshold temperature is below a burn temperature of the aerosol generating product.

19. The system of claim 16, wherein the instructions are configured to, when executed by the processing circuitry, cause the processing circuitry to monitor the magnetic permeability of the one or more temperature sensing elements by causing the processing circuitry to monitor for a change in the magnetic permeability of the one or more temperature sensing elements.

20. The system of claim 16, wherein the instructions are configured to, when executed by the processing circuitry, cause the processing circuitry to control the at least one temperature of the aerosol generating product based on the determined at least one temperature by causing the processing circuitry to
increase the at least one temperature based on a determination that one or more of the determined at least one temperature is at or below a first threshold temperature, and
pause the increase of the at least one temperature based on a determination that one or more of the determined at least one temperature is at or above a second threshold temperature.
